(19) United States
(12) Patent Application Publication
(10) Pub. No.: US 2012/0266063 A1
(43) Pub. Date: Oct. 18, 2012

(54) Systems and Methods for Creating and Maintaining a Customized Version of a Master Document

(76) Inventor: Christopher G. Bushnell, Salt Lake City, UT (US)

(21) Appl. No.: 13/086,381

(22) Filed: Apr. 13, 2011

(51) Int. Cl. G06F 17/00

(52) U.S. Cl. 715/255

(57) ABSTRACT

Methods for managing updates to customized documents and customized master documents including customized specification documents include receiving an update containing updated information for inclusion in a previously customized specification document, determining whether the updated information of the update impacts a customized portion of the previously customized specification document, and selectively merging the updated information with the previously customized specification document to generate a new customized specification document. The update and/or any impacted customizations may be presented to a user to permit the user to provide input into how the updated information and the previously customized specification document should be merged to generate the new customized specification document. Metadata regarding customizations of the previously customized specification document and metadata regarding any updates incorporated into the new customized specification document may be tracked and stored with the customized specification documents to facilitate merging of the updates and the customized information.

### CROSS-REFERENCE TO RELATED APPLICATIONS

This application is related to copending application Ser. No. 13/086,374, filed Apr. 13, 2011 and titled Systems and Methods for Propagating Information Between Various Levels of a Construction Specification, attorney docket no. 18189.2, which is incorporated herewith by reference for all it discloses.

### BACKGROUND OF THE INVENTION

1. Field of the Invention

The present invention relates to construction specifications, and more particularly to systems and methods that propagate modifications between various versions of a construction specification.

2. Background and Related Art

Construction specifications, along with drawings, are prepared as part of the contract documents for constructing a facility and are typically assembled into a Project Manual along with the bidding documents. The current state of the art for preparing specifications ranges from writing a specification from “scratch”, using a prewritten manufacturer's proprietary specification, using the specification from the last project, or using a commercial master specification and editing it to generate the specification. Commercial master specifications currently are provided as word processing files or as a database. Each word processing file is a separate specification section. In the database iteration, the entire specification is stored in one file. In both cases, the user edits the content of the master specification to achieve the appropriate information for the project.

Construction specifications are the culmination of a myriad of decisions that have been made throughout the project design process. Traditionally, construction specification documents, including office master specifications, are created by specifiers using word processing files or in a database. A user typically prepares or creates an office master specification to establish the user's or office's preferences for the most-used products and materials as well as for the types of projects that the firm designs and specifies.

Office master specifications attempt to simplify the decisions that are made during the design process by recording the firm's preferences beforehand. Specifiers can thereafter prepare project specifications more quickly, and with assurance that the products and materials have already been researched and deemed to be acceptable for use. Just as for project specifications, creating an office master specification requires that a specifier must determine the appropriate features, capabilities, and attributes of the products, materials, and systems that will be included. Once that has been done, the specifier must include the appropriate language in the specification.

Until now, there has been no easy and accurate method for creating, maintaining and managing office master specifications, especially as it relates to maintaining an office master specification in conjunction with a commercial master specification. Commercial master specification providers typically send updates to their master text on a periodic basis. When these are received, the specifier needs to merge the updated text with the preferences that were previously made. This process is manual and painstaking, and involves comparing the old and updated text, and then copying the office master text into the appropriate locations in the updated master text. Similar problems may be encountered in industries other than the construction specification industry.

### BRIEF SUMMARY OF THE INVENTION

Implementation of the invention provides systems, methods, and non-transitory computer-readable media storing computer instructions for implementing methods for managing updates to customized documents and customized master documents including customized specification documents such as office master specifications. A computer-aided method for managing updates to a customized specification document includes receiving, at a computer system, an update containing updated information for merging with a previously customized specification document, using the computer system to determine whether the updated information of the update impacts a customized portion of the previously customized specification document, and selectively merging the update containing updated information with the previously customized specification document to generate a new customized specification document.

The previously customized specification document may include collections of master text clauses drawn from a master specification. When an update is made to one or more master text clauses in the master specification, the computer system conducts an evaluation of the previously customized specification document and determines whether the update should be incorporated with corresponding clauses in the previously customized specification document to generate the new customized specification document. When the corresponding clauses have not been customized the system may automatically utilize the updated information in the new customized specification document. When the corresponding clauses in the previously customized specification document have been customized, either the updated information from the corresponding clauses in the update are not utilized or a user is notified of the update to the one or more master text clauses, provides an indication as to whether to update any corresponding clauses in the previously customized specification document, and the updated information and any corresponding clauses in the previously customized specification documents are selectively merged as indicated by the user.

The master text clauses may include master text clauses describing administrative requirements of construction products, materials, systems, and assemblies, master text clauses describing the installation requirements of construction products, materials, systems, and assemblies, master text clauses listing the manufacturers of construction products, materials, systems, and assemblies, and master text clauses identifying the construction standards that apply to construction products, materials, systems, and assemblies. The master text clauses may be stored in a relational database system and may include master text clauses incorporating specific attributes for inclusion in specification documents, master checklists summarizing attributes for inclusion in specification documents with links to the master text clauses, master question-and-answer dialogs summarizing attributes for inclusion in specification documents with links to the master text clauses, and master classification systems defining how specification documents should be assembled. The relational database system may be provided on a server and accessed by a client computer device over a network or the Internet.

Implementation of the invention may also provide systems, methods, and non-transitory computer-readable media storing computer instructions for implementing a method for managing updates to a previously customized master document. A method for managing updates to a customized master document includes receiving an update containing updated information for merging with a previously customized master document, determining whether the updated information of the update impacts a customized portion of the previously customized master document, and selectively merging the updated information with information from the previously customized master document to generate a new customized master document.

When the updated information does not impact a customized portion of the previously customized master document, selectively merging the updated information with information from the previously customized master document may include one of automatically merging corresponding portions of the previously customized master document and the update without user input and presenting the update to a user, receiving input from the user as to how the updated information should be incorporated with the previously customized master document, and merging the updated information of the update with the customized portion of the previously customized master document according to the input from the user.

Thus, the update may be presented to a user to permit the user to provide input into how the updated information and the customized portion of the previously customized master document should be merged to generate the new customized master document. The user may provide input into how the updated information and the previously customized master document should be merged using a graphical user interface.

In some instances, the new customized master document is generated by incorporating the update into the previously customized master document. In other instances, the update includes an updated template master document, and the new customized master document is generated by incorporating customized portions of the previously customized master document into the updated template master document.

Metadata regarding customizations of the previously customized master document and metadata regarding any updates incorporated into the new customized master document may be tracked and stored with the new customized master document. The previously customized master document, the update, and the new customized master document may utilize a data structure permitting automatic location of corresponding elements between the previously customized master document and the update regardless of differences between the corresponding elements. When differences between corresponding elements between the previously customized master document and the update are so significant that the corresponding elements cannot be automatically located, a user may be presented with a graphical user interface to correctly position at least one of the update and the customized portion in the new customized master document. The customized master document may be associated with a project, which may be a construction project or may be associated with a construction project. Alternatively, the project may be in any of a variety of other fields where documents are to be assembled with differing levels of detail and/or customization.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system that may be used with embodiments of the invention;

FIG. 2 shows a representative networked computer system that may be used with embodiments of the invention;

FIG. 3 illustrates a hierarchical representation of a relationship between various illustrative construction documents; and

FIGS. 4-7 show flow charts illustrating methods in accordance with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems, methods, and non-transitory computer-readable media storing computer instructions for implementing methods for managing updates to customized documents and customized master documents including customized specification documents such as office master specifications. A computer-aided method for managing updates to a customized specification document includes receiving, at a computer system, an update containing updated information for merging with a previously customized specification document, using the computer system to determine whether the updated information of the update impacts a customized portion of the previously customized specification document, and selectively merging the update containing updated information with the previously customized specification document to generate a new customized specification document.

The previously customized specification document may include collections of master text clauses drawn from a master specification. When an update is made to one or more master text clauses in the master specification, the computer system conducts an evaluation of the previously customized specification document and determines whether the update should be incorporated with corresponding clauses in the previously customized specification document to generate the new customized specification document. When the corresponding clauses have not been customized the system may automatically utilize the updated information in the new customized specification document. When the corresponding clauses in the previously customized specification document have been customized, either the updated information from the corresponding clauses in the update are not utilized, or a user is notified of the update to the one or more master text clauses, provides an indication as to whether to update any corresponding clauses in the previously customized specification document, and the updated information and any corresponding clauses in the previously customized specification documents are selectively merged as indicated by the user.

The master text clauses may include master text clauses describing administrative requirements of construction products, materials, systems, and assemblies, master text clauses describing the installation requirements of construction products, materials, systems, and assemblies, master text clauses listing the manufacturers of construction products, materials, systems, and assemblies, and master text clauses identifying the construction standards that apply to construction products, materials, systems, and assemblies. The master text clauses may be stored in a relational database system and may include master text clauses incorporating specific attributes for inclusion in specification documents, master checklists summarizing attributes for inclusion in specification documents with links to the master text clauses, master question-and-answer dialogs summarizing attributes for inclusion in specification documents with links to the master text clauses, and master classification systems defining how specification documents should be assembled. The relational database system may be provided on a server and accessed by a client computer device over a network or the Internet.

Embodiments of the invention may also provide systems, methods, and non-transitory computer-readable media storing computer instructions for implementing a method for managing updates to a previously customized master document, which may be associated with a project. A method for managing updates to a customized master document includes receiving an update containing updated information for merging with a previously customized master document, determining whether the updated information of the update impacts a customized portion of the previously customized master document, and selectively merging the updated information with information from the previously customized master document to generate a new customized master document.

When the updated information does not impact a customized portion of the previously customized master document, selectively merging the updated information with information from the previously customized master document may include one of automatically merging corresponding portions of the previously customized master document and the update without user input and presenting the update to a user, receiving input from the user as to how the updated information should be incorporated with the previously customized master document, and merging the updated information of the update with the customized portion of the previously customized master document according to the input from the user.

Thus, the update may be presented to a user to permit the user to provide input into how the updated information and the customized portion of the previously customized master document should be merged to generate the new customized master document. The user may provide input into how the updated information and the previously customized master document should be merged using a graphical user interface.

In some instances, the new customized master document is generated by incorporating the update into the previously customized master document. In other instances, the update includes an updated template master document, and the new customized master document is generated by incorporating customized portions of the previously customized master document into the updated template master document.

Metadata regarding customizations of the previously customized master document and metadata regarding any updates incorporated into the new customized master document may be tracked and stored with the new customized master document. The previously customized master document, the update, and the new customized master document may utilize a data structure permitting automatic location of corresponding elements between the previously customized master document and the update regardless of differences between the corresponding elements. When differences between corresponding elements between the previously customized master document and the update are so significant that the corresponding elements cannot be automatically located, a user may be presented with a graphical user interface to correctly position at least one of the update and the customized portion in the new customized master document. The customized master document may be associated with a project, which may be a construction project or may be associated with a construction project. Alternatively, the project may be in any of a variety of other fields where documents are to be assembled with differing levels of detail and/or customization.

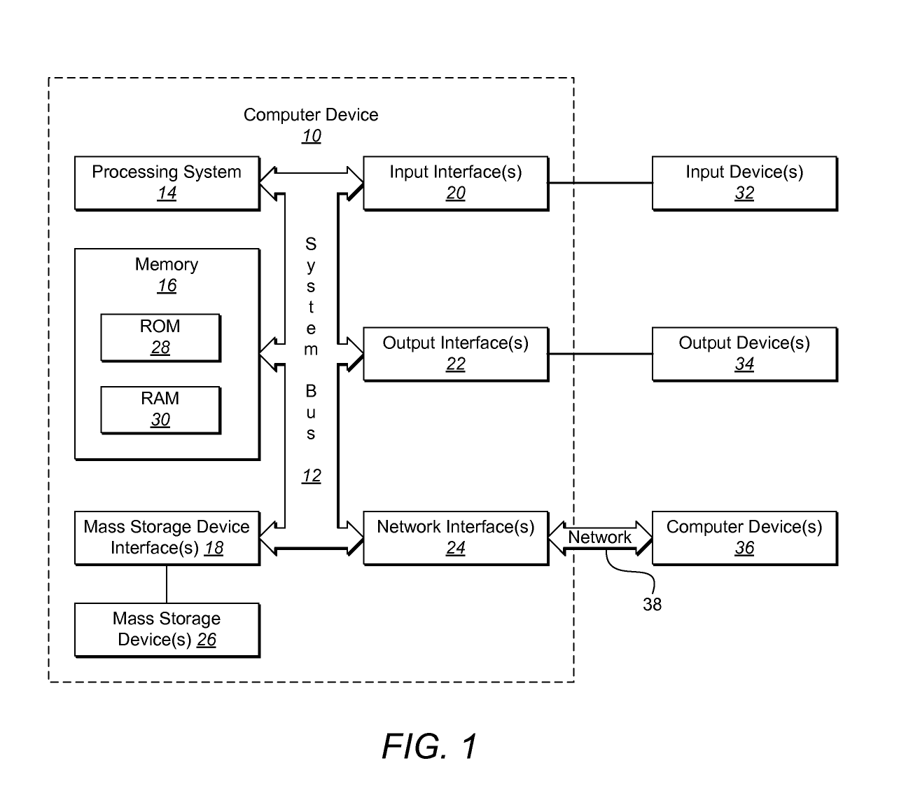

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, touchscreen, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

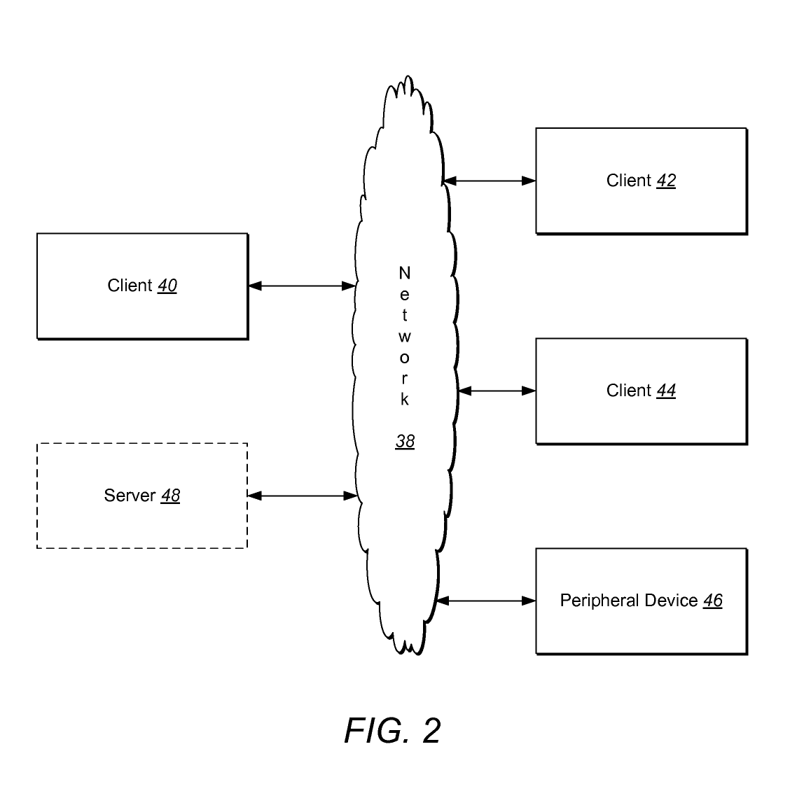

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Embodiments of the invention eliminate many of the problems inherent with current office master specification creation and maintenance in the construction industry as well as similar problems in other industries. Utilizing embodiments of the invention, the design professional is able to set preferences in the office master specification, which preferences are tracked to permit distinguishing between the customized preferences and information from the original source specification document (e.g. commercial master specification). The preferences in the office master specification can then readily be compared to any later changes to any specification document, including a commercial master specification, the office master specification itself, or a project specification document. Embodiments of the invention thus reduce or eliminate the need to manually search for, recognize, review, and apply potential changes (e.g. updates) to the office master specification to maintain it.

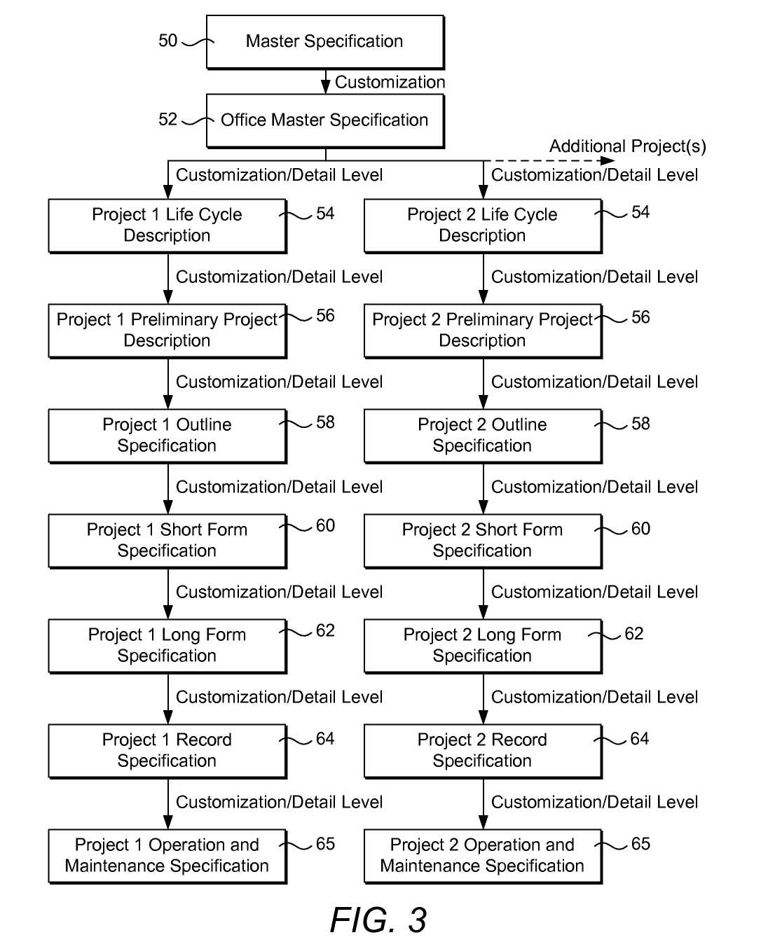

To assist in understanding an environment in which embodiments of the invention may prove useful, FIG. 3 illustrates various levels of specification documents that may be applicable to a particular project. The details of FIG. 3 are intended to be illustrative, and it should be understood that various embodiments may include more or fewer document levels than those illustrated in FIG. 3.

FIG. 3 illustrates a situation especially applicable to the construction industry and construction products, and it will be understood that the specific documents illustrated in FIG. 3 can be modified for other applicable industries and projects, where “projects” should be understood to be any desirable goal, task, or other tangible or intangible end result, including the making of a template document (e.g. an office master specification) to facilitate the creation of other documents. For example, in the construction industry, a project may be a building, infrastructure, or other structure, facility, or some portion thereof. In the insurance industry, a project may be an insurance policy and/or a total insurance package of policies. These are merely illustrative uses of the term “project” as it relates to embodiments of the invention.

In FIG. 3, there are various specification levels illustrated in a hierarchical arrangement. FIG. 3 shows a master specification 50 and an office master specification 52. The master specification 50 may include a variety of master text clauses and may therefore be part of or include a database of master text clauses, which may be stored on a local computer system or on a remote computer system, including a server, accessed over a local or remote network, including the Internet. In many instances, the master specification 50 is maintained as a commercial service by a master specification provider. As part of the commercial service, the master specification provider ensures that the master specification 50 reflects current construction standards, available products and materials, available manufacturers, construction options, and the like, and forwards updates to the master specification 50 to subscribers of the commercial service from time to time as the various standards, products, materials, manufacturers, options and the like change.

The office master specification 52 may be considered a sub master specification. The office master specification 52 may be customized for use by an office or group and may be customized from the master specification 50 in ways that facilitate use by the office or group. The customization of the office master specification 52 reflects preferences of the office or group, and commonly reduces the work that must be performed by professionals within the office or group to create specification documents for various projects of the office or group. The office or group need not be located at a single physical location to utilize the office master specification 52.

The office master specification 52 may be customized, for example, by eliminating certain master text clauses as options for the office's or group's projects as being options not needed or never to be used by the office or group. For example, if a certain product, material, system, assembly, manufacturer, or feature is unneeded or unavailable in a certain area for whatever reason (e.g. the manufacturer does not ship to that location, the local climate dictates using other products, etc.), then any applicable master text clauses (e.g. from the master specification 50) may be eliminated. As another example, if the office or group determines that it will use a certain brand or manufacturer of certain types of products, master text clauses referring to products of other brands or manufacturers may be eliminated. Customization of this type may facilitate increased efficiency of specification generation within the office or group.

Other types of customization may also be available. For example, custom master text clauses may be added to the office master specification 52 that are not available in the master specification 50. For example, if the office or group is aware of local manufacturers that are not included in the master text clauses of the master specification 50 for whatever reason (e.g. they are unknown to the entity maintaining the master specification 50 or have not opted to be included in the master specification 50), the office or group may wish to have products of the local manufacturers available for their specification documents. Still other customization may involve changing master text clauses to reflect preferences of the office or group. Thus, it may be seen that many forms of customization may occur between the master specification 50 and the office master specification 52.

A series of project-specific specification documents may be generated by the office or group. For example, as illustrated in FIG. 3, each of a first project and a second project may have one or more of the following documents associated with it at any point in time: a life cycle description 54, a preliminary project description 56, an outline specification 58, a short form specification 60, a long form specification 62, a record specification 64, and an operation and maintenance specification 65. More or fewer documents may be utilized depending on the needs associated with a specific project, and the office master specification 52 may therefore have information and a level of specificity corresponding to any level of the documents shown in FIG. 3. Similarly, an office or group may have an office master specification 52 corresponding to each level of document shown in FIG. 3 to the extent that such office master documents may assist the processes of the office or group. Additionally, while two projects are illustrated in FIG. 3, it should be understood that embodiments of the invention may be utilized with any number of projects.

As may be appreciated from the foregoing and from FIG. 3, the level of detail contained in each of the documents shown in FIG. 3 may vary from document to document. For example, the master specification 50 may include master text clauses covering a wide variety of administrative requirements, construction materials, products, systems, assemblies, installation requirements, manufacturers, construction standards, features, capabilities, attributes, industry standards, performance criteria, product designations, and the like in industry-standard language and format, but anything from a small to a large amount of this information may be irrelevant to a particular project. Similarly, the life cycle description 54 for a first project may include a level of detail significantly less detailed than is needed, for example, in the long form specification 62 for the project. Thus, each document may have a level of detail applicable to the particular needs associated with that document.

The office master specification 52 may include master text clauses covering a wide variety of administrative requirements, construction materials, products, systems, assemblies, installation requirements, manufacturers, construction standards, features, capabilities, attributes, industry standards, performance criteria, product designations, and the like in industry-standard language and format. As with the master specification 50, anything from a small to a large amount of this information may be irrelevant to a particular project, but the office master specification 52 may be customized so as to reduce or eliminate information normally contained in the master specification 50 that a particular office or group finds to always or nearly always be irrelevant to the office's or group's projects. Additionally, the office master specification 52 may be customized to add information that tends to be relevant to at least some of the office's or group's projects but is not included in the master specification. Similarly, the office master specification 52 may be customized to change information contained in the master specification 50 so as to make the changed information more relevant to at least some of the office's or group's projects. In all instances, the office master specification 52 is customized to facilitate the office's or group's practices by reducing the amount of time a specifier writing a specification document will need to create that document by reducing and eliminating time spent in reviewing and modifying the master text clauses contained in the master specification 50 for each project.

Of course, it should be understood that any document of the type shown in FIG. 3 may be customized as discussed herein, and may serve as a template for other documents and projects, and the discussion herein with respect to updating a customized master document such as the office master specification 52 applies equally to any customized document or customized master document. While the use of a customized master specification 52 as described herein (or any similarly customized document or customized master document in a related field) can greatly enhance productivity, it can be important for the office master specification 52, even as customized, to be updated from time to time. This is why many people pay a service to ensure access to updates provided to the master specification 50. For example, if an office master specification 52 has been customized to select a particular manufacturer's products as the preferred option for the office's or group's projects, and that manufacturer either goes out of business or discontinues manufacture of the selected products, it is important that this information be conveyed to the office or group and be reflected in the office's or group's specification documents so that replacement products can be selected. Otherwise, it could become difficult for the projects to be completed properly, as the late-stage substitution of other products could greatly affect a project and could require other changes to a project's plans.

Similarly, if a government entity updates or otherwise changes an applicable building code, the change must be reflected in the office's or group's projects or the projects could risk failing code inspections. As may be appreciated, any such failure could lead to significant cost overruns in correcting the code violations, and some code violations could be difficult to impossible to correct without significant modifications to the project's plans. Thus, for reasons such as these, it is generally desirable to permit and facilitate updating of any customized specification document, including the office master specification 52.

There are significant difficulties in updating a customized master document. When a typical commercial master specification provider sends updates to their master text clauses, the office or group needs to merge the updated text with the preferences and other customizations that were previously made, which can be a manual and painstaking process involving comparing the old and updated text and copying the customized office master text into the appropriate locations in the updated master text. Similar difficulties can be encountered with updating any other document. Embodiments of the invention reduce and eliminate many of these difficulties by tracking preferences (e.g. deletions, changes, and additions) made to the office master specification 52 as they are originally made, permitting the preferences to be readily viewed and more-easily compared to later changes in any relevant document. Thus, if a later change (e.g. update) is made to the master specification 50, the office master specification 52, or one of the project specification documents, and a change is to be reviewed for potential incorporation into another document, it can be readily shown and either accepted, rejected, or modified by the specifier as it is incorporated (or not) into the desired document.

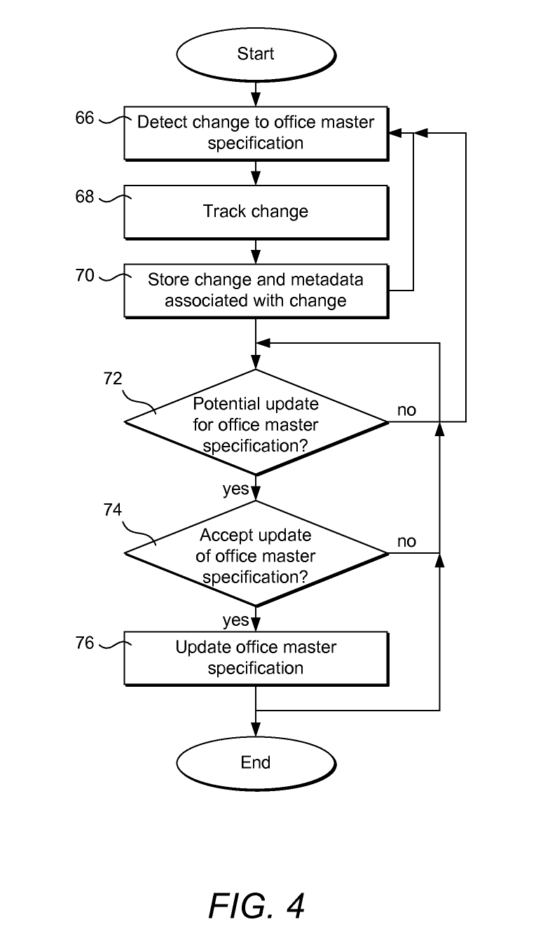

Processes according to an illustrative embodiment of the invention will be illustrated with reference to FIG. 4, using the customization and updating of the office master specification 52 as an example. Execution begins as the office master specification 52 is originally being customized. At step 66, a change being made to the office master specification 52 is detected. The change may be any type of change, including a deletion of unneeded text from the master specification 50, a changing of text, or the addition of custom text not available in the master specification 50. At step 68, the detected change is tracked as it is made to the original source specification. Tracking of the change may include generating automatic and/or custom metadata about the change. Automatic metadata may be generated by a system or program facilitating customization of the office master specification 52, including author of the change, date and/or time of the change, the nature of the change, and the like. Custom metadata about the change may be generated upon request of the user or the user may be prompted or required to include custom metadata when making changes. Custom metadata may include one or more reasons for making the change as well as any other desired user-defined attributes.

At step 70, the changes and any associated metadata are stored. The stored data includes the location and extent of the changes to the office master specification 52 so as to reflect the user's preferences. At least some of the changes may be stored as modifications to an underlying data structure. The stored data permits display of the data in any of a variety of ways to allow a specifier to readily distinguish the changes and preferences from the original commercial master specification 50 as well as from any updates provided in an updated commercial master specification 50 or other applicable document. Steps 66 through 70 may of course be repeated for any and all changes, and may occur repeatedly during one or more customization sessions as necessary for generation of the office master specification 52. Additionally, steps 66 through 70 may occur at a point in time removed from a time period associated with later steps illustrated in FIG. 4.

Where steps 66 through 70 relate to the initial customization of the office master specification 52, the later steps relate to generating an updated office master specification 52 based on changes or updates to another specification document. Commonly, the other specification document will be the master specification 50 and the updates are provided through the commercial update service, but changes and other updates may be provided through other documents and means as well. For example, if a change is made to one or more project documents (e.g. one of the documents 54 through 65 shown in FIG. 3) that is incompatible with the contents of the office master specification 50, and the person making the changes determines that the change should be incorporated into the office master specification 52 for use in other projects, an update may be made or suggested to the office master specification 52 based on the change in the project document.

For example, a person working on a project might discover that a local construction code has changed that has not otherwise been updated in the master specification 50 and/or the office master specification 52. Similarly, the person might discover that a product specified in the office master specification 52 (whether contained in the master specification 50 or as customized text only available in the office master specification 52) is no longer readily available. Additionally, the person might simply discover an error in the information contained in the office master specification 52. These are merely examples of instances that might prompt a suggested or needed change or update to the office master specification 52 but not received as an update to the master specification 50. Thus, changes to the office master specification 52 may be received from any of a variety of sources, and may include metadata such as a reason for the requested or required change to assist in determining whether a change to the office master specification 52 should in fact be made.

Regardless of the source of the change, changes to the office master specification 52 may be made in one of a variety of fashions. In one example, changes or updates to the office master specification 52 are made by detecting changes and/or updates from a source of changes and/or updates and by making changes to the office master specification 52. In an alternate example, an updated master specification 50 is received and detected, and a new office master specification 52 is generated by customizing the new master specification 50 into the new office master specification 52 using the tracked changes and metadata stored in association with the old office master specification 52, as will be discussed in more detail shortly.

Thus, in FIG. 4, execution proceeds to decision block 72, where a determination is made as to whether a potential update for the office master specification 52 has been detected. If no such update has been detected, execution loops back either to step 66 or immediately prior to decision block 72 for the process to continue as outlined previously until a potential update for the office master specification 52 is detected. When a potential update is detected, execution proceeds to decision block 74 for a determination as to whether to accept the update of the office master specification 52 and proceed with updating the office master specification 52. A potential update need not necessarily be made immediately, but may be archived or stored until a later time until the potential update is to be accepted.

In making the determination of whether or not the update is to be accepted, any of a variety of processes may be utilized, and acceptance of an update may be automatic, only manual, or some form of process in between automatic and manual. For example, in some instances, the system may be configured to automatically accept certain types of updates, including changes to construction codes, safety features and requirements, and the like. In other instances, manual acceptance of the update may be required in all instances. Some offices may program the system to automatically accept all updates from the master specification 50 and to hold all updates from any other source (e.g. project specification documents) pending approval. The foregoing are merely examples of how a proposed update may be handled by the system.

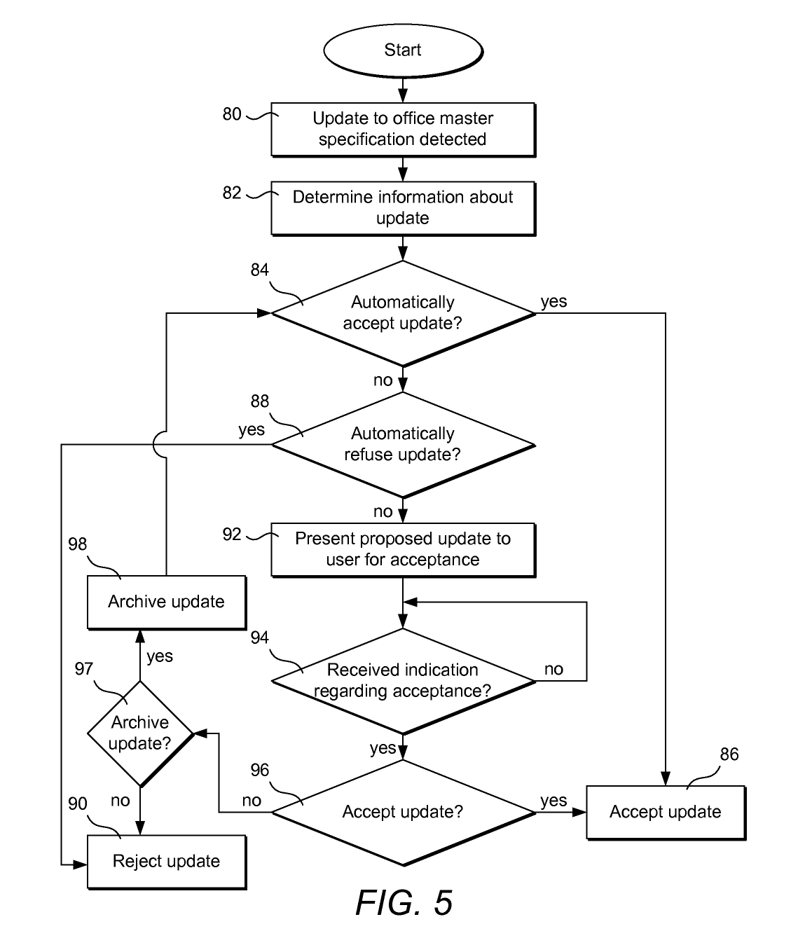

As the handing of a decision to accept an update may be handled in various manners with varying levels of manual input, FIG. 5 illustrates in more detail illustrative processes that may occur in making the decision as to whether or not to accept an update to the office master specification. Execution begins at step 80 with detection of an update or potential update to the office master specification 52. At step 82, information about the update is determined, such as information regarding the source of the update and whether any metadata about the update is available. For example, a determination could be made as to whether the update was provided by the commercial entity providing updates to the master specification 50. Similarly, a determination could be made as to a priority level assigned to the update (e.g. a critical update required to ensure projects comply with code requirements vs. a minor update in a definition of a certain manufacturer's product). Any metadata provided with the update could be evaluated in determining information about the update. Of course, it will be understood that any update could actually involve many updates to different portions of the office master specification 52, and the step of determining information about the update could involve separate determinations as to any portion of such updates.

At decision block 84, a determination is made as to whether the update (or any portion thereof) should be automatically accepted. If yes, execution proceeds to step 86 where the update is accepted, or at least that portion that should be automatically accepted is accepted. If not, execution proceeds to decision block 88, where a determination is made as to whether the update (or any portion thereof) should be automatically rejected, such as according to preferences previously set for handling of certain updates or if it is determined that a proposed update has no effect on the office master specification 52 (alternatively, an update to text deleted from the customized office master specification 52 may be made but remain deleted, depending on how text deleted from the office master specification 52 is handled). A proposed update may have no effect on the office master specification 52, for example, if it is a change to text that has been deleted by customizations to the office master specification 52. If the update is to be automatically rejected, execution proceeds to step 90, where the proposed update is rejected, or at least that portion that should be automatically rejected is rejected.

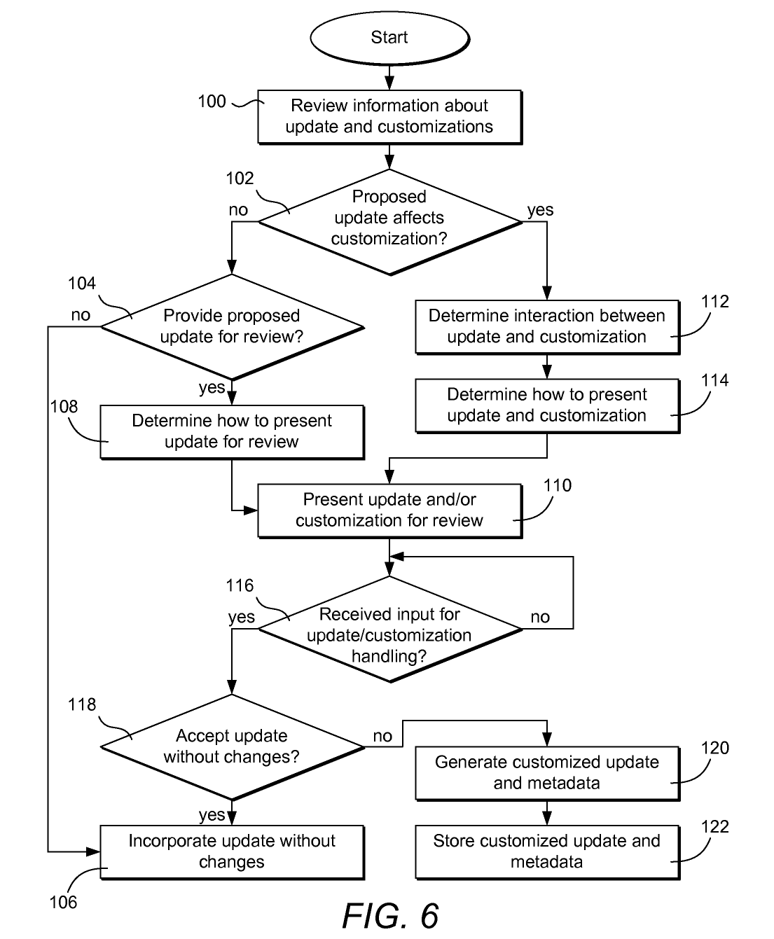

For the update or portion thereof that should not be automatically accepted or rejected, execution proceeds to step 92, where the proposed update is presented to the user for acceptance. The update may be presented to the user at step 92 at a point in time removed from the initial detection of the update at step 80, and the update (or any portions thereof not automatically accepted or rejected) may be archived or otherwise held until such time as it is presented to the user at step 92. The update may be presented in any of a variety of fashions, including an alert such as an alert upon initiating a program, by highlighting portions of potentially-affected specification documents including the office master specification 52 and/or project specification documents for any unfinished projects, and the like. The proposed update may be presented textually and/or graphically, and any of a variety of interfaces may be provided to the user to show the proposed update and to permit the user to provide an indication as to whether the update should be accepted or rejected. In addition, as will be discussed in more detail with respect to the remaining portions of FIG. 4 and FIG. 6, the user's acceptance or rejection of a proposed update may be combined with an indication of where and/or how any accepted updates should be incorporated into the office master specification 52.

In FIG. 5, after the proposed update is presented to the user for acceptance at step 92, execution proceeds to decision block 94, where a determination is made as to whether the user has provided an indication regarding whether the proposed update is to be accepted or rejected. Until such an indication has been received, execution loops at this point. When such an indication is received, execution proceeds to decision block 96, where a determination is made as to whether the update is to be accepted or rejected. If the update is accepted, execution proceeds to step 86, and if the proposed update is rejected, execution proceeds to decision block 97, where a determination is made as to whether the update is to be rejected or merely archived for later consideration. If the update is not initially accepted, it may simply be that the user wishes to review and process the update or portion thereof at a later time. Thus, if the update is not accepted, is also not rejected, but is instead designated to be stored or archived, execution proceeds to step 98, where the update or portion thereof is archived. After the update or portion thereof is archived, execution can loop back to any point permitting future handling of the archived update, which is illustrated by showing execution returning to decision block 84. If the update is instead designated for rejection, execution proceeds from decision block 97 to step 90, where the update is rejected. Thereupon, execution terminates with respect to that specific update.

If the update is not to be accepted for whatever reason as illustrated at decision block 74 of FIG. 4, such as illustrated in the process of FIG. 5, execution of the process of FIG. 4 loops back as shown, which may involve later processing or consideration of the update and/or processing or consideration of other updates. If, however, the update is accepted, execution of the process of FIG. 4 proceeds to step 76, where the office master specification 52 is updated, whereupon the process may terminate or may return to any point prior in the process for processing of further updates and changes, as illustrated.

As discussed earlier, the updating of the office master specification 52 as at step 76 should be handled in an intelligent fashion to ensure that the blending of updates and customizations to generate an updated office master specification 52 occurs in a way that best preserves the preferences expressed in the earlier version of the office master specification 52. Otherwise, the update of the office master specification 52 could result in inefficiencies for the office or group using the office master specification 52. Therefore, FIG. 6 illustrates representative processes that may occur in the update of the office master specification at step 76. In many instances, the processes shown in FIG. 6 can occur simultaneously with the processes of FIG. 5. For purposes of this discussion, it should be assumed that the update referenced in FIG. 6 is one that is accepted or is to be accepted in whole or in part for current processing (e.g. has not been rejected or archived for later consideration).

Execution begins at step 100, where information about the update along with information about customizations to the office master specification is reviewed. The review may be manual, automatic, or partially manual and partially automatic. Regardless, at decision block 102, a determination is made as to whether the proposed update affects a customized portion of the office master specification 52. While some updates will potentially affect customized portions of the office master specification 52 and must therefore be handled more carefully to ensure that the preferences expressed in customizations are not unknowingly affected by incorporation of updates, other updates may not affect customized portions of the office master specification 52, and may therefore be less likely to adversely affect an office's or group's preferences.

If it is determined that a proposed update does not affect a customization, execution proceeds to decision block 104, where a determination is made as to whether to provide a proposed update for manual review. Regardless of whether a proposed update affects a customized portion of the office master specification 52, it may still be desirable in at least some instances to provide such proposed updates for review before incorporating them into a revised office master specification 52. For example, a proposed update may adversely affect a preference expressed by leaving a portion of the original specification text uncustomized. As another example, it may be desirable to review an update to become aware of potential changes such as building code changes, changes in manufacturer products, and the like, so as to allow users to adopt their practices and preferences to new information contained in the updates.

The result of the determination of decision block 104 may be based on any of a variety of factors, such as user preferences for handling of updates previously entered into the system, the type of update, and information such as metadata provided with the update. For example, a user might previously select to always view updates relating to construction code changes only prior to incorporating updates into the office master specification 52. Similarly, a user might previously select to always view updates relating to product changes. In some instances, the entity maintaining the master specification 50 and providing an update thereto may specify in metadata associated with the update that it should be presented to all subscribers to ensure that changes in critical information are not ignored. Indeed, the provider of the update service may wish to ensure that proof is provided that certain updates were manually reviewed and accepted to limit potential liability. In some instances, the system may be unable to determine a correct location for the update and may need to provide the update for review and insertion into the correct location of the office master specification 52.

Regardless, if it is determined at decision block 104 that a proposed update need not be reviewed prior to being incorporated, execution proceeds to step 106, and the update is incorporated without any modifications to the update itself. If, however, it is determined that the update should be provided for review for whatever reason, execution proceeds to step 108. At this step, a determination is made as to how to present the update for review. Each update may be handled differently, and many different manners of presenting updates may be used. For example, an update may be provided as a notification upon initialization of the program for writing specifications. Alternatively, updates may be provided to all affected documents when those documents are accessed using various different systems or methods to show changes (e.g. color, highlighting, underline/strikethrough, and the like). Various graphical user interfaces may be used, along with any presentation methodology and technology known in the art. How the update will be presented may be varied depending on the content and/or extent of the update, as well as based upon metadata accompanying the update. Once it is determined how to present the update for review, it is presented to the user at step 110.

Returning to decision block 102, if it is determined that a proposed update affects a customized portion of the office master specification 52, execution proceeds to step 112, where the system determines an interaction between the update and the customization. The interaction may be minor or extensive, and may be governed by various considerations, including the importance attached to the customization by the office or group, the importance of the update as discussed above, and any metadata included in the customization or in the update. Based on this information, a determination is made at step 114 as to how to present the update in relation to the customization, with considerations similar to those discussed with respect to step 108. Execution then proceeds to step 110, where the update and customization are presented to the user for review.

From step 110, execution proceeds to decision block 116, where a determination is made as to whether input has been received to direct how to handle the update, as well as any potential interaction between the update and any prior customizations. The input for handling the update and/or customization may be as simple as a single entry of acceptance or rejection, or may be complex, including additional customization of the prior customization and/or of the update. Until some input for handling of the update and/or customization is received, execution loops at decision block 116. When a sufficient input to direct handling of the update and/or interaction of the update and the prior customization is received, execution then proceeds to decision block 118.

At decision block 118, a determination is made as to whether the update should be accepted without changes. If yes, execution proceeds to step 106, where the update is incorporated into the revised office master specification 52 without changes to the update. Where the update is incorporated without changes to the update at step 106, it may involve changing portions of the office master specification 52 that were not customized (after review according to steps 108 and 110), or it may involve overwriting prior customizations.

If the update should not be accepted and incorporated without changes, execution proceeds to steps 120 and 122, where a customized update is generated and stored in the office master specification 52, along with metadata about the update, similar to the metadata generated and stored in step 70 of FIG. 4. The metadata may include automatically generated and/or custom metadata about the update and/or customization. Automatic metadata may be generated by the system or program facilitating customization of the office master specification 52, including author, date and/or time, the nature of any change and customizations, and the like. Custom metadata about the change may be generated upon request of the user or the user may be prompted or required to include custom metadata when merging the updates and customizations (if any). Custom metadata may include one or more reasons for making the change as well as any other desired user-defined attributes.

Thus, the stored data again includes the location and extent of the changes to the office master specification 52 so as to reflect the user's preferences. At least some of the changes may be stored as modifications to an underlying data structure. The stored data permits display of the data in any of a variety of ways to allow a specifier to readily distinguish the changes and preferences from the original and/or updated commercial master specification 50 or other applicable document. It may be seen that essentially any change may be handled essentially as an update and that any update may be handled essentially as a proposed change to the office master specification 52, with special handling occurring to ensure that the office's or group's preferences remain reflected in any updated office master specification 52.

While the foregoing examples discussed with respect to FIG. 6 illustrate a method for managing updates that involve incorporating updates into a specification document such as the previous office master specification 52 to generate an updated specification document such as an updated office master specification 52, this is merely one example of managing the updating of a customized document or customized master document. As mentioned previously, another method for generating an updated customized document or customized master document may involve a similar process whereby the customizations present in a customized document or customized master document may be incorporated into an updated document to generate a customized updated document or customized updated master document.

For example, returning to the example of a customized office master specification 52 and an update to the master specification 50 provided by a commercial entity, the commercial entity may provide an updated master specification 50. Rather than incorporate updated portions of the updated master specification 50 into the customized office master specification 52 to generate an updated customized master specification 52, the customizations present in the office master specification 52 may be incorporated into the updated master specification 50. Thus, as mentioned above, any update may essentially be handled as a customization and any customization may essentially be handled as an update.

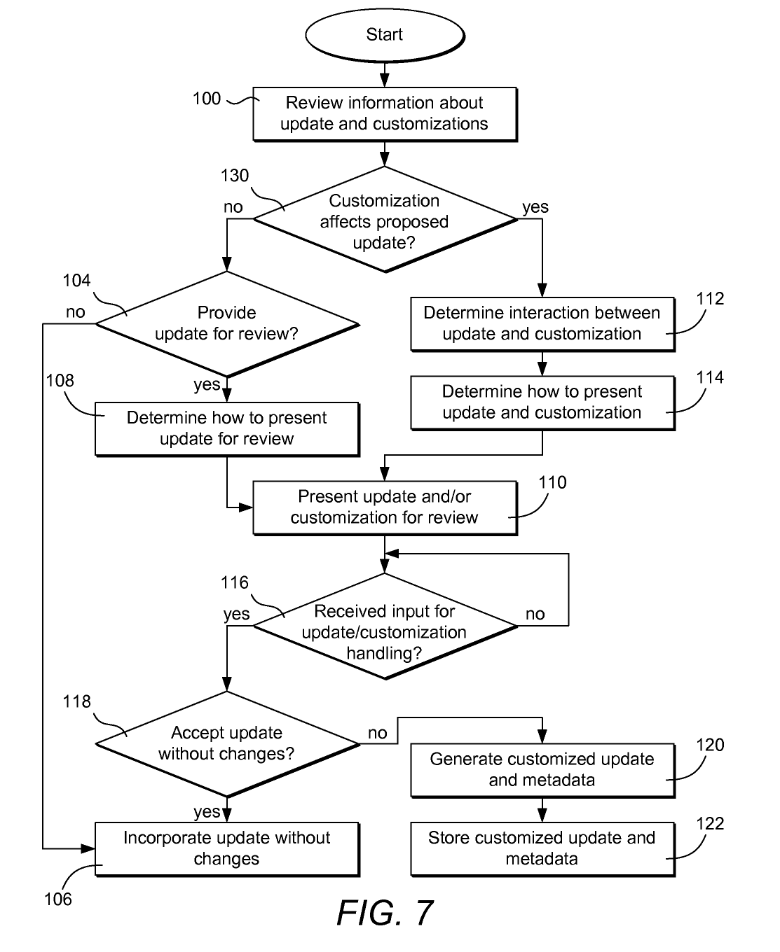

Thus, turning to FIG. 7, a further exemplary process for managing an update as at step 76 of FIG. 4 is illustrated. Many of the steps illustrated in FIG. 7 are essentially identical to those steps illustrated in FIG. 6, and the previous discussion related to those steps in FIG. 6 is equally applicable to the process illustrated in FIG. 7, though not repeated here in detail. The first differing aspect of the process of FIG. 7 is located at decision block 130, where a determination is made as to whether a customization present in the old version of the customized office master specification 52 impacts a proposed update contained in the updated master specification 50 (instead of the other way around as depicted in FIG. 6). If not, then execution proceeds to decision block 104 as in FIG. 7, and if so, execution proceeds to step 112. As decision block 104 and steps 108-122 are essentially preserved from the process of FIG. 6, the update may be intelligently handled, and information may optionally be presented to the user to determine how best to integrate or merge the update and any customization.

In the process of FIG. 7, any customizations of any type may be considered for presentation to the user for review at step 110, and although not specifically illustrated in FIG. 7, some customizations may be automatically handled and incorporated into the updated master specification 50 as part of generating the updated office master specification 52 with customizations. For example, if the customization is a deletion of text from the master specification 50, and the system determines that the updated master specification 50 does not include an update impacted by the deletion, the customization may simply be incorporated by deleting the unchanged portion of the master specification.

Similarly, if the updated version of the master specification 50 includes changed text that is deleted in the customized office master specification 52 and the system determines that the change is of a priority such that it needs not be presented to the user (or if metadata associated with the customization dictates automatic incorporation of the customization in any update or any update having a designated level of importance), the customization may be incorporated into the updated master specification 50 as part of the process of generating the updated office master specification 52 by deleting the changed portion of the master specification. Alternatively, various considerations may demand or require presentation of the update and/or the customization to the user to ensure that the user has viewed the update and/or has opted to incorporate the update with or without any customizations. As with the process depicted in FIG. 6, this may be desirable, for example, with respect to updates to building codes and the like.

Any other type of customization, including the addition of customized text and/or the modification of standard text in the master specification 50 may be handled similarly, whether automatically or via some form of presentation to the user followed by manual input received from the user to direct handling of the merging of the customization into the master specification 50 to generate the updated office master specification 52. As with the process illustrated in FIG. 6, the process of FIG. 7 permits tracking of updates and customizations through the use of metadata that may be automatically or manually generated and stored.

Embodiments of the invention facilitate updates and review of the office master specification 52 while maintaining preferences expressed in customization as per the processes described above. The process of updating and review is facilitated through the use of automated computer-implemented processes that may automatically detect and display potential changes, thereby reducing manual processes in incorporating potential changes. To facilitate and automate the review, the correct location for corresponding elements of, for example, an updated commercial master specification 50 and a customized office master specification 52 may be determined through the use of various data structures, metadata and the like.

As one example, a change to the commercial master specification 50 may involve the generation of metadata showing the text and location of the original, unmodified information. Similarly, a customization of the office master specification 52 may involve the generation of similar metadata showing the text and location of the original, unmodified information (which was taken from the original, unmodified commercial master specification 50). When the update is to be made to the customized office master specification 52, the respective metadata can be used to locate the corresponding sections and permit automated identification of the correct location for the proposed update, even though the information from the original commercial master specification 50 is no longer present in its original form in the office master specification 52.

Each change that is made during the customization and update process may be tracked such that potentially any change or update may be reversed at a later time if circumstances or changing preferences so demand. An opportunity to make or accept a change may be provided by way of text editing, checklists, question and answer dialogs, and the like. Where a change is provided by way of use of a master checklist or a question-and-answer format, the user is not required to read through an entire master specification to look for applicable master text clauses, instead, any applicable master text clauses are then assembled, such as from a database, and are automatically displayed and incorporated in an industry-standard format at an appropriate level of detail and ready for the desired change. The information, changed or unchanged, and any metadata relating to changed information may be stored as a relational database system. The relational database system may include master text clauses incorporating and defining specific features, capabilities, and/or attributes to be included in the specification document(s). In some iterations, the database is stored on a central network server and is accessed by software on a client computer connected to the network server. In other iterations, the database is stored on a web server and is accessed by software on a client computer connected to the web server over the Internet.

As may be appreciated from the foregoing description, various levels of documents may be linked together as needed within a project. The documents may also be assembled and/or stored together. The linking, assembly, and storage of documents may occur using any methods, systems, and computer languages now known or later invented. By way of example, structured text as described in U.S. Pat. No. 5,341,469, which is incorporated herein by reference for all it discloses, may be used in assemblage, storage, and linkage of various documents, as can extensible markup language (XML), Industry Foundation Classes XML (ifcXML), and hyperlinks, as applicable. The foregoing should be understood as merely being examples that can be used with or by embodiments of the invention. The use of a general data structure may assist in the tracking, changing, and updating of the office master specification 52, as the use of common data structures may facilitate properly locating corresponding specification elements, including updates and customizations.

As one example, one or more of the following general data structure objects and elements may be used: 1) type objects, which are physical objects and materials in a construction project; 2) type object specializations, which are distinct variations of type objects; 3) properties, which describe the characteristics and attributes of type objects and type object specializations, and which include but are not limited to attributes, values of attributes, units of measure, and test methods; 4) parts, which are components or portions of a type object or type object specialization; 5) classification, which is a method for: a) organizing specification sections, such as MasterFormat produced by the Construction Specifications Institute (CSI) and Construction Specifications Canada (CSC), b) organizing the specification content and its order within sections, such as SectionFormat produced by CSI and CSC, c) classifying type of specification content, such as the type of specification documents illustrated in FIG. 3, d) identifying specialized specification content, such as a LEED-related requirement, and e) originating party of the content; 6) description, which is the actual specification text clause; 7) values, which are the variables that apply to properties; 8) common measure, which are the units of measure that apply to values; 9) resources, which are information from external data sources, such as standards and codes, about type objects and type object specializations; 10) sources, which are manufacturer and product data about type objects and type object specializations; 11) links, which are data on internal references within the specification documents illustrated in FIG. 3; and 12) notes, which are advisory information about type objects, type object specializations, properties, values, resources, and sources.

Where a data structure such as this one is used, the underlying data structure may be used to correctly place and locate preferences expressed as customizations and/or updates to generate an updated office master specification 52. For example, if the updated office master specification 52 is generated by applying previous customizations to an updated master specification 50, the underlying data structure generally permits automatic determination of the correct location in the updated master specification 50 to incorporate customizations present in the past office master specification 50. The user may be able to override the automatic placement of customized sections, such as by manually dragging and dropping customized sections into a desired location in the updated office master specification 52 using a graphical user interface. Similarly, in instances where the correct location to place a customized section cannot be automatically determined, such as by using the underlying data structure, the user can use a process such as manually dragging and dropping the customized sections into a desired location using the graphical user interface.

Embodiments of the invention may be used in essentially any field of use where creation or assembly of documents is desired using master text clauses. Embodiments of the invention are especially helpful for use in instances where documents of varying levels of detail are desired. Thus, as discussed herein, embodiments of the invention are particularly useful in the area of construction specification generation. In such embodiments, the master text clauses may include (1) clauses describing administrative requirements of construction products, materials, systems, and assemblies, (2) clauses describing the characteristics of construction products, materials, systems, and assemblies, (3) clauses describing the installation requirements of construction products, materials, systems, and assemblies, (4) clauses listing the manufacturers of construction products, materials, systems, and assemblies, (5) clauses including the construction standards that apply to the construction products, materials, systems, and assemblies, and (6) clauses incorporating a specific feature, capability, and/or attribute to be included in a specification document, which may (a) describe physical, functional, and performance characteristics of the construction products, materials, systems, and assemblies, (b) be specified using descriptions, reference to industry standards, performance criteria, and/or product designations, and (c) be written in industry-standard language and format. Of course, the foregoing list is intended to be merely illustrative of an exemplary scope of a set of master text clauses applicable to one field of use of embodiments of the invention.

As another example of a potential field of use, embodiments of the invention may be utilized to assemble an insurance policy from a database of insurance policy clauses (e.g. master text clauses). The assembly of the insurance policy may occur using a master checklist of coverages, exclusions, and endorsements selected by the user (e.g. an insurance professional). In such an embodiment, the master text clauses may include any possibly-applicable insurance policy clauses, governing regulations, and the like in industry-standard language. The foregoing is merely one example of an alternate field of use for embodiments of the invention. Embodiments of the invention may be utilized in any other desirable field of use.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A computer-aided method for managing updates to a customized specification document, the method comprising:
receiving, at a computer system, an update containing updated information for merging with a previously customized specification document;
using the computer system to determine whether the updated information of the update impacts a customized portion of the previously customized specification document; and
selectively merging the update containing updated information with the previously customized specification document to generate a new customized specification document.

2. A method as recited in claim 1, wherein the customized specification document comprises an office master specification.

3. A method as recited in claim 2, wherein the office master specification is a master specification for a specification document selected from the group of:
a project life cycle description;
a preliminary project description;
an outline specification;
a short form specification;
a long form specification;
a record specification; and
an operation and maintenance specification.

4. A method as recited in claim 1, wherein the previously customized specification document comprises collections of master text clauses drawn from a master specification.

5. A method as recited in claim 4, wherein when the update is made to one or more master text clauses in the master specification, the computer system conducts an evaluation of the previously customized specification document and determines whether the update should be incorporated with corresponding clauses in the previously customized specification document to generate the new customized specification document.

6. A method as recited in claim 5, wherein the computer system determines to automatically utilize the updated information in the new customized specification document when corresponding clauses in the previously customized specification document have not been customized.

7. A method as recited in claim 5, wherein the computer system determines that the corresponding clauses in the previously customized specification document have been customized and takes an action selected from the group of:
determining not to utilize the updated information from the corresponding clauses in the update; and
notifying a user of the update to the one or more master text clauses, receiving an indication from the user as to whether to update any corresponding clauses in the previously customized specification document, and selectively merging the updated information and any corresponding clauses in the previously customized specification documents as indicated by the user.

8. A method as recited in claim 4, wherein the master text clauses comprise at least one of:
master text clauses describing administrative requirements of construction products, materials, systems, and assemblies;
master text clauses describing properties and performance requirements of construction products, materials, systems, and assemblies;
master text clauses describing the installation requirements of construction products, materials, systems, and assemblies;
master text clauses listing the manufacturers of construction products, materials, systems, and assemblies; and
master text clauses identifying the construction standards that apply to construction products, materials, systems, and assemblies.

9. A method as recited in claim 4, wherein the master text clauses are stored in a relational database system comprising:
master text clauses incorporating specific attributes for inclusion in specification documents;
master checklists summarizing attributes for inclusion in specification documents with links to the master text clauses;
master question-and-answer dialogs summarizing attributes for inclusion in specification documents with links to the master text clauses; and
master classification systems defining how specification documents should be assembled.

10. A method as recited in claim 9, wherein the relational database system is provided on a server and accessed by a client computer device over a network or the Internet.

11. A non-transitory computer-readable medium storing computer-readable instructions for implementing a method for managing updates to a previously customized master document, the method comprising:
receiving an update containing updated information for merging with a previously customized master document;
determining whether the updated information of the update impacts a customized portion of the previously customized master document; and
selectively merging the updated information with information from the previously customized master document to generate a new customized master document.

12. A non-transitory computer-readable medium as recited in claim 11, wherein the master document comprises an office master specification document associated with a construction project.

13. A non-transitory computer-readable medium as recited in claim 11, wherein when the updated information does not impact a customized portion of the previously customized master document, selectively merging the updated information with information from the previously customized master document comprises an action selected from the group of:
automatically merging corresponding portions of the previously customized master document and the update without user input; and
presenting the update to a user, receiving input from the user as to how the updated information should be incorporated with the previously customized master document, and merging the updated information of the update with the customized portion of the previously customized master document according to the input from the user.

14. A non-transitory computer-readable medium as recited in claim 11, wherein the method further comprises presenting the update to a user to permit the user to provide input into how the updated information and the customized portion of the previously customized master document should be merged to generate the new customized master document.

15. A non-transitory computer-readable medium as recited in claim 14, wherein the user provides input into how the updated information and the previously customized master document should be merged using a graphical user interface.

16. A non-transitory computer-readable medium as recited in claim 11, wherein the new customized master document is generated by incorporating the update into the previously customized master document.

17. A non-transitory computer-readable medium as recited in claim 11, wherein the update comprises an updated template master document, and wherein the new customized master document is generated by incorporating customized portions of the previously customized master document into the updated template master document.

18. A non-transitory computer-readable medium as recited in claim 11, wherein metadata regarding customizations of the previously customized master document and metadata regarding any updates incorporated into the new customized master document are tracked and stored with the new customized master document.

19. A non-transitory computer-readable medium as recited in claim 11, wherein the previously customized master document, the update, and the new customized master document utilize a data structure permitting automatic location of corresponding elements between the previously customized master document and the update regardless of differences between the corresponding elements.

20. A non-transitory computer-readable medium as recited in claim 19, wherein when differences between corresponding elements between the previously customized master document and the update are so significant that the corresponding elements cannot be automatically located, a user is presented with a graphical user interface to correctly position at least one of the update and the customized portion in the new customized master document.
